(19) United States
(12) Patent Application Publication
(10) Pub. No.: US 2019/0349318 A1
(43) Pub. Date: Nov. 14, 2019

(54) METHODS AND APPARATUS FOR SERIALIZED ROUTING WITHIN A FRACTAL NODE ARRAY

(71) Applicant: The Board of Trustees of the Leland Stanford Junior University, Stanford, CA (US)

(72) Inventors: Sam Fok, Stanford, CA (US); Kwabena Boahen, Stanford, CA (US)

(21) Appl. No.: 16/358,501

(22) Filed: Mar. 19, 2019

Related U.S. Application Data
(60) Provisional application No. 62/668,529, filed on May 8, 2018.

(51) Int. Cl. H04L 12/935; H04L 12/753; G06N 3/04

(52) U.S. Cl. CPC H04L 49/3009; G06N 3/04; H04L 45/48

(57) ABSTRACT

Methods and apparatus for messaging within a neuromorphic array of compute primitives. Existing networking techniques are poorly suited for the intermediate complexity of neuromorphic computing. Consequently, novel router architectures described herein efficiently propagate messaging within a neuromorphic system. In one exemplary embodiment, a fractal tree of client nodes is disclosed. The fractal tree includes embedded tree switches that use path-based routing to deliver packets. The exemplary path-based routing is simplified and more robust relative to other alternatives. Additionally, an asynchronous handshaking protocol with serial signaling enables a processor to communicate with a very large neuromorphic array of compute primitives without any shared timing for the system; i.e., the client nodes can take as long (or as little) as is necessary to communicate.

### PRIORITY

This application claims the benefit of priority to U.S. Provisional Patent Application Serial No. 62/668,529 filed May 8, 2018 and entitled “DATA/PACKET ROUTER INVOLVING TREE TOPOLOGY”, which is incorporated herein by reference in its entirety.

### STATEMENT REGARDING FEDERALLY SPONSORED RESEARCH OR DEVELOPMENT

This invention was made with Government support under contracts N00014-15-1-2827 and N00014-13-1-0419 awarded by the Office of Naval Research and under contract NS076460 awarded by the National Institutes of Health. The Government has certain rights in the invention.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. TECHNICAL FIELD

The disclosure relates generally to the field of neuromorphic computing, as well as neural networks. More particularly, the disclosure is directed to methods and apparatus for messaging within a neuromorphic array of compute primitives. In one exemplary embodiment, the neuromorphic array includes a plurality of compute primitives arranged in a fractal structure to minimize physical routing and/or logical addressing complexity. In one such variant, the messaging may be asynchronously routed via serial links according to a handshaking procedure.

### 2. DESCRIPTION OF RELATED TECHNOLOGY

Traditionally, computers include at least one processor and some form of memory. Computers are programmed by writing a program composed of processor-readable instructions to the computer's memory. During operation, the processor reads the stored instructions from memory and executes various arithmetic, data path, and/or control operations in sequence to achieve a desired outcome. Even though the traditional compute paradigm is simple to understand, computers have rapidly improved and expanded to encompass a variety of tasks. In modern society, they have permeated everyday life to an extent that would have been unimaginable only a few decades ago.

While the general compute paradigm has found great commercial success, modern computers are still no match for the human brain. Transistors (the components of a computer chip) can process many times faster than a biological neuron, however this speed comes at a significant price. For example, the fastest computers in the world can perform nearly a quadrillion computations per second (10¹⁶ bits/second) at a cost of 1.5 megawatts (MW). In contrast, a human brain contains ˜80 billion neurons and can perform approximately the same magnitude of computation at only a fraction of the power (about 10 watts (W)).

Incipient research is directed to so-called “neuromorphic computing” which refers to very-large-scale integration (VLSI) systems containing circuits that mimic the neuro-biological architectures present in the brain. While neuromorphic computing is still in its infancy, such technologies already have great promise for certain types of tasks. For example, neuromorphic technologies are much better at finding causal and/or non-linear relations in complex data when compared to traditional compute alternatives. In the future, neuromorphic technologies could be used to perform speech and image recognition within power-constrained devices (e.g., cellular phones, etc.). Conceivably, neuromorphic technology could integrate energy-efficient intelligent cognitive functions into a wide range of consumer and business products, from driverless cars to domestic robots.

Traditional techniques for organizing computational resources within a network are divided into so-called “centralized” and “distributed” computation. Centralized computing commonly refers to systems that concentrate a large amount of computational resources within a relatively small portion of the network. Common examples of centralized computing include e.g., enterprise mainframes and/or cloud computing. In contrast, distributed computing systems distribute computational resources over the entire network. Distributed computing techniques are widely applied in peer-to-peer type applications.

Neuromorphic computing substantially differs from general compute paradigms; some aspects of neuromorphic computing might be considered “centralized” and some aspects could be considered “distributed.” For example, the computational primitives that mimic neuro-biological architectures (e.g., so-called “somas”) could be considered a distributed system of very simple processing elements. However, the outputs of the computational primitives are collected and interpreted by centralized processing logic (such as threshold accumulators, etc.) In other words, neuromorphic processing cannot be categorized as either centralized or distributed; instead, it may best be described as an “intermediate complexity” or “hybridized” computing architecture.

Unfortunately, existing networking techniques are poorly suited for the intermediate complexity of neuromorphic computing. For example, high-overhead routers (e.g., meshes with parallel interfaces) capable of communicating arbitrary data-types at high bandwidths, are poorly suited for intermediate-complexity clients with low data-rate requirements. Similarly, low-overhead routers may suffer from real-world physical effects that limit the number of clients that can be supported in an intermediate-complexity system. Thus, intermediate complexity router architectures must balance client complexity as well as the number of clients.

To these ends, novel router architectures are needed to efficiently propagate messaging within a neuromorphic system. Ideally, such solutions should enable mixed-signal neuromorphic circuitry to operate at very low power, with large variations in time, and scale in complexity (e.g., to emulate thousands, tens of thousands, and eventually millions or more of neuromorphic client nodes). More generally, improved methods and apparatus are needed for messaging within a neuromorphic array of compute primitives.

### SUMMARY

The present disclosure satisfies the foregoing needs by providing, inter alia, methods and apparatus for messaging within a neuromorphic array of compute primitives.

In one aspect, a neuromorphic apparatus is disclosed. In one embodiment, the neuromorphic apparatus includes: a node array including a plurality of switching nodes and a plurality of computation nodes; where each switching node of the plurality of switching nodes has a plurality of addressable ports and the plurality of switching nodes are hierarchically nested; where each computation nodes of the plurality of computation nodes is addressable with a hierarchically nested set of addressable ports; a processor; and a non-transitory computer readable medium. In one exemplary embodiment, the non-transitory computer readable medium includes a plurality of instructions that, when executed by the processor, cause the processor to: generate a first packet including a first plurality of addresses; provide the first packet to the node array; and where each address of the first plurality of addresses identifies a corresponding addressable port from a first hierarchically nested set of addressable ports.

In one variant, the first packet further includes a neuromorphic weight for a first computation nodes that is addressable with the first hierarchically nested set of addressable ports.

In one variant, the first packet further includes an exciting or inhibiting spike for a first computation nodes that is addressable with the first hierarchically nested set of addressable ports.

In one variant, each switching node of the plurality of switching nodes is configured to: responsive to receiving a packet: identify an addressable port from an address of a plurality of addresses; remove the address from the plurality of addresses; and forward the packet to a switching node or a computation node coupled to the addressable port.

In one variant, the plurality of instructions are further configured to, when executed by the processor, cause the processor to: receive a second packet including a second plurality of addresses; where each address of the second plurality of addresses identifies a corresponding addressable port from a second hierarchically nested set of addressable ports; and where the second packet indicates a spike for a second computational node that is addressable with the second hierarchically nested set of addressable ports.

In one variant, the plurality of switching nodes are hierarchically nested in a fractal topology. In one exemplary variant, the fractal topology is a H-tree.

In one variant, the plurality of switching nodes of the node array are coupled via a plurality of serial links. In one exemplary variant, the plurality of serial links are characterized by asynchronous dual rail signaling.

In one aspect, a method for asynchronous handshake-based packet transfer within an array of nodes is disclosed. In one embodiment, the method includes: responsive to receiving a packet: splitting the packet into an address portion and a forwarding portion; identifying an addressable port from a plurality of addressable ports based on the address portion; and arbitrating for control of the addressable port. In one exemplary embodiment, for each bit of the forwarding portion, the method includes: transmitting the bit responsive to an enable signal; incrementing to a next bit responsive to an acknowledge signal; and releasing control of the addressable port after a last bit of the forwarding portion has been transmitted.

In one variant, transmitting the bit responsive to the enable signal includes dual rail signaling.

In one variant, the packet is received from another node of the array of nodes.

In one variant, transmitting the bit responsive to the enable signal includes transmitting to another node of the array of nodes. In one exemplary variant, the another node of the array of nodes includes a fractal tree switching node. In another exemplary variant, the another node of the array of nodes includes a computational node.

In one aspect, a method for addressing a packet to a computational node of a tree network, where the tree network includes a plurality of computational node addressable via a plurality of switching nodes is disclosed. In one embodiment, the method includes: generating a payload for the computational node; for each layer of the tree network, appending an address that identifies an addressable port of a switching node of a set of switching nodes at the layer; and asynchronously transmitting the packet via an asynchronous serial link of the tree network.

In one variant, the tree network includes a binary tree (B-tree).

In one variant, tree network includes a self-similar fractal H-tree.

In one variant, the method further includes generating an exciting or inhibiting spike for the computational node.

In one variant, the generating the payload includes assigning a neuromorphic weight for the computational node.

Various example embodiments are directed to circuits and methods in which data (e.g., as a packet or block of data) is routed through a network of circuit-based nodes. In such embodiments, an array of so-called clients are interconnected in a tree topology in which at least one tree includes nodes with links/channels interconnecting the nodes by way of data/packet routing and logical addressing. In accordance with the instant disclosure, a router is designed to facilitate communication of data/packets between the array of clients which corresponds to one or more environment-application circuits, and the tree topology includes a transmitter tree and/or a receiver tree, and each such tree is associated with or included as part of the router and interconnected via the links/channels. Each tree is designed to code received/transmitted signals to effect insensitivity of signal delay for signals conveyed to and/or from each node, and/or is designed to communicate the signals serially through the tree by using a serial protocol.

The circuitry, including the aforementioned tree architecture, can be designed to be time insensitive to signal delays including signal propagation delays (e.g., attributable to environmental conditions such as changes/tolerances involving component temperature and voltages) and to be time insensitive to data-processing delays (e.g., where delays depend on or are attributable to protocols used to send data packets through the network.

In many instances, both transmitter and receiver trees are used. It will also be appreciated that these (circuit-based designs) may be implemented in such manners so as to avoid needing to (re)configure/program each (added) node as the tree(s) might expand. For example, the circuitry can be designed (e.g., configured during manufacture) into the hardware and/or layout so as to facilitate a plug-and-play ability to use and add/remove nodes from the system. In these regards, routers and a network of switches can be designed to communicate data/packets through the array by a process of automatically generating addresses, wherein the transmitter and/or the receiver are designed to autonomously (e.g., designed into hardware/layout) generate array addresses for an extensible set of nodes in the tree of nodes (e.g., in which the number of extensible nodes in the set is arbitrary and wherein address-encoding or decoding for the extensible nodes is not performed by one or more separate circuits).

In more specific embodiments, the array of clients can be circuit elements of a neural network, the tree can be arranged in a fractal pattern (e.g., by an H-based branch arrangement) and can be arranged with a link-width which is constant for different payload sizes. As further specific variants, each physical routing node (e.g., on the transmitter side of the communication) may include logical addressing circuitry. In one such variant, the logical addressing circuitry includes hand-shaking circuitry that can be configured and arranged to perform a multi-way (e.g., two-way or four-way) arbitration process. In some cases, the serial communication protocol may be used to propagate packets through the trees (e.g., in the transmitter and in the receiver); and a 1-of-N code (where N is a positive integer, e.g., 1-of-2 or 1-of-4 code) may be used for communications across each channel.

Other important exemplified features concern ways to use the serial protocol. As examples, each transmitter node can be designed to implement data/packet merging and arbitration processes on top of the serial protocol, and each receiver node can be designed to implement a data/packet splitting process on top of the serial protocol.

Yet further important example features concern ways to reach each client specifically. As examples, these features include uniquely identifying a client in the array by prepending the addresses of the requesting child nodes to the packet as communications progress toward the root of the tree, and uniquely addressing a client in the array by reading off the address of the requested child node (e.g., from the head of the packet), and optionally stripping/removing the head, as communications progress toward the leaf of the tree.

Various blocks, modules or other circuits may be implemented to carry out one or more of the operations and activities described herein and/or shown in the figures. In these contexts, a “block” (also sometimes referred to as “logic circuitry” or “module”) is a circuit that carries out one or more of these, or related, operations/activities. For example, in certain of the above-discussed embodiments, one or more modules are discrete logic circuits or programmable logic circuits configured and arranged for implementing these operations/activities. In certain embodiments, such a programmable circuit is one or more computer circuits programmed to execute a set (or sets) of instructions (and/or configuration data). The instructions (and/or configuration data) can be in the form of firmware or software stored in and accessible from a memory (circuit). As an example, first and second modules include a combination of a CPU hardware-based circuit and a set of instructions in the form of firmware, where the first module includes a first CPU hardware circuit with one set of instructions, and the second module includes a second CPU hardware circuit with another set of instructions.

Certain embodiments are directed to a computer program product (e.g., non-volatile memory device), which includes a machine or computer-readable medium having stored thereon instructions which may be executed by a computer (or other electronic device) to perform these operations/activities.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a logical block diagram of an exemplary neural network, useful for explaining various principles described herein.

FIG. 2 is a graphical representation of an approximation of a mathematical signal represented as a function of neuron firing rates, useful for explaining various principles described herein.

FIG. 3 is a graphical representation of a spiking neural network, useful for explaining various principles described herein.

FIG. 4A is a logical block diagram of a high-overhead router scheme, useful for explaining various principles described herein.

FIG. 4B is a logical block diagram of a low-overhead router scheme, useful for explaining various principles described herein.

FIG. 5A is a logical block diagram of an exemplary tree-based neuromorphic system, in accordance with the various principles described herein.

FIG. 5B is a side-by-side comparison of an exemplary H-tree and grid array of equal link-widths, useful for explaining various principles described herein.

FIG. 6 is a side-by-side comparison of logical addressing in an exemplary H-tree array and a grid array, useful for explaining various principles described herein.

FIG. 7 is a graphical representation of an exemplary asynchronous serial handshaking protocol, useful for explaining various principles described herein.

FIGS. 8A-8B are logical block diagrams of exemplary methods for messaging within a neuromorphic array of compute primitives, in accordance with the various principles described herein.

FIG. 9 is a logical block diagram of one exemplary embodiment of a spiking neural network, useful in conjunction with the various principles described herein.

All figures © Copyright 2018-2019 Stanford University, All rights reserved.

### DETAILED DESCRIPTION

Reference is now made to the drawings, wherein like numerals refer to like parts throughout.

### Detailed Description of Exemplary Embodiments

Exemplary embodiments of the present disclosure are now described in detail. While these embodiments are primarily discussed in the context of spiking neural network computing, it will be recognized by those of ordinary skill that the present disclosure is not so limited. In fact, the various aspects of the disclosure are useful in any device or network of devices that is configured to perform intermediate complexity computing, as is disclosed herein.

### Neuromorphic Computing

Many implementations of neural networks treat neuron operation in a “virtualized” or “digital” context; each idealized neuron is individually programmed with various parameters to create different behaviors. For example, biological spike trains are emulated with numeric parameters that represent spiking rates, and synaptic connections are realized with matrix multipliers of numeric values. Idealized neuron behavior can be emulated precisely and predictably, and such systems can be easily understood by artisans of ordinary skill.

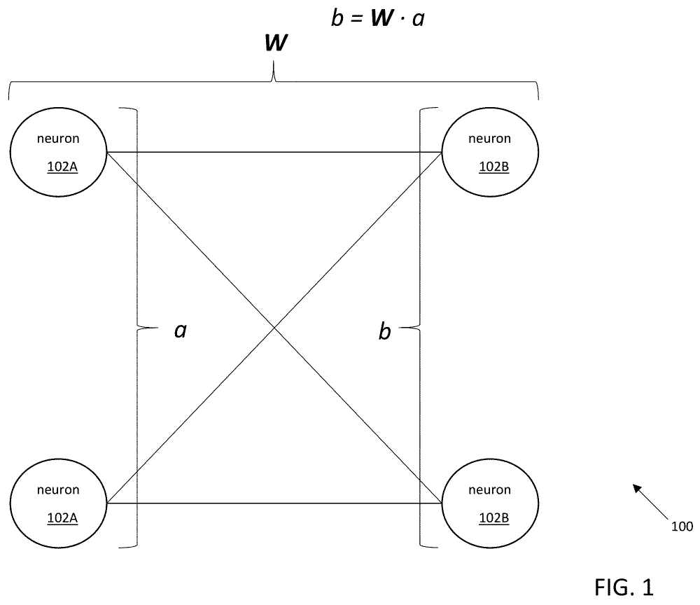

FIG. 1 is a logical block diagram of an exemplary neural network, useful for explaining various principles described herein. The exemplary neural network 100, and its associated neurons 102 are “virtualized” software components that represent neuron signaling with digital signals. As described in greater detail below, the various described components are functionally emulated as digital signals in software processes rather than e.g., analog signals in physical hardware components.

As shown in FIG. 1, the exemplary neural network 100 includes an arrangement of neurons 102 that are logically connected to one another. As used herein, the term “ensemble” and/or “pool” refers to a functional grouping of neurons. In the illustrated configuration, a first ensemble of neurons 102A is connected to a second ensemble of neurons 102B. The inputs and outputs of each ensemble emulate the spiking activity of a neural network; however, rather than using physical spiking signaling, existing software implementations represent spiking signals with a vector of continuous signals sampled at a rate determined by the execution time-step.

During operation, a vector of continuous signals (a) representing spiking output for the first ensemble is transformed into an input vector (b) for a second ensemble via a weighting matrix (W) operation. Existing implementations of neural networks perform the weighting matrix (W) operation as a matrix multiplication. The matrix multiplication operations include memory reads of the values of each neuron 102A of the first ensemble, memory reads of the corresponding weights for each connection to a single neuron 102B of the second ensemble, and a multiplication and sum of the foregoing. The result is written to the neuron 102B of the second ensemble. The foregoing process is performed for each neuron 102B of the second ensemble.

Heterogeneous neuron programming is necessary to emulate the natural diversity present in biological and hardware neurons (e.g., both vary widely in behavior and characteristics). The Neural Engineering Framework (NEF) is one exemplary theoretical framework for computing with heterogeneous neurons. Various implementations of the NEF have been successfully used to model visual attention, inductive reasoning, reinforcement learning, and many other tasks. One commonly used open-source implementation of the NEF is Neural Engineering Objects (NENGO), although other implementations of the NEF may be substituted with equivalent success by those of ordinary skill in the related arts given the contents of the present disclosure.

Existing neural networks individually program each idealized neuron with various parameters to create different behaviors. However, such granularity is generally impractical to be manually configured for large scale systems. The NEF allows a human programmer to describe the various desired functionality at a comprehensible level of abstraction. In other words, the NEF is functionally analogous to a compiler for neuromorphic systems. Within the context of the NEF, complex computations can be mapped to a population of neurons in much the same way that a compiler implements high-level software code with a series of software primitives.

In one such implementation of the NEF, a desired computation may be decomposed into a system of sub-computations that are functionally cascaded or otherwise coupled together. Each sub-computation is assigned to a single group of neurons (a “pool”). A pool's activity encodes the input signal as spike trains. This encoding is accomplished by giving each neuron of the pool a “preferred direction” in a multi-dimensional input space specified by an encoding vector. As used herein, the term “preferred direction” refers to directions in the input space where a neuron's activity is maximal (i.e., directions aligned with the encoding vector assigned to that neuron). In other words, the encoding vector defines a neuron's preferred direction in a multi-dimensional input space. A neuron is excited (e.g., receives positive current) when the input vector's direction “points” in the preferred direction of the encoding vector; similarly, a neuron is inhibited (e.g., receives negative current) when the input vector points away from the neuron's preferred direction.

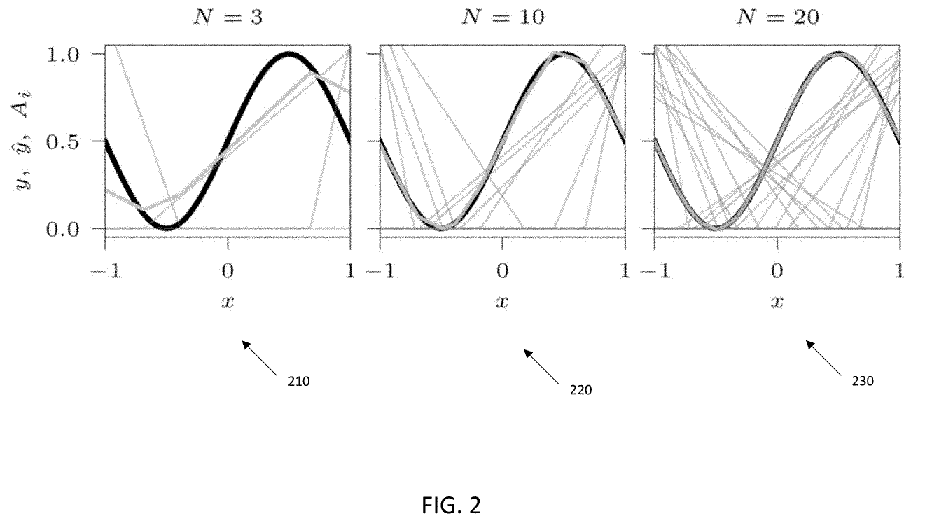

Given a varied selection of encoding vectors and a sufficiently large pool of neurons, the neurons' non-linear responses can form a basis set for approximating arbitrary multi-dimensional functions of the input space by computing a weighted sum of the responses (e.g., as a linear decoding). For example, FIG. 2 illustrates three (3) exemplary approximations 210, 220, and 230 of a mathematical signal (i.e., y=sin(πx)+l))/2) being represented as a function of neuron firing rates (i.e., ŷ=Ad). As shown therein, each column of the encoding matrix A represents a single neuron's firing rates over an input range. The function ŷ is shown as a linear combination of different populations of neurons (e.g., 3, 10, and 20). In other words, a multi-dimensional input may be projected by the encoder into a higher-dimensional space (e.g., the aggregated body of neuron non-linear responses has many more dimensions than the input vector), passed through the aggregated body of neurons' non-linear responses, and then projected by a decoder into another multi-dimensional space.

As shown in FIG. 2, approximation error can be adjusted as a function of neuron population. For example, the first exemplary approximation of y with a pool of three (3) neurons 210 is visibly less accurate than the second approximation of y using ten (10) neurons 220. However, higher order projection eventually reaches a point of diminishing returns; for example, the third approximation of y using twenty (20) neurons 230 is not substantially better than the second approximation 220. More generally, artisans of ordinary skill in the related arts will readily appreciate that more neurons (e.g., 20) can be used to achieve higher precision, whereas fewer neurons (e.g., 3) may be used where lower precision is acceptable.

The aforementioned technique can additionally be performed recursively and/or nested hierarchically. For example, recurrently connecting the output of a pool to its input can be used to model arbitrary multidimensional non-linear dynamic systems with a single pool. Similarly, large network graphs can be created by connecting the output of decoders to the inputs of other decoders. In some cases, linear transforms may additionally be interspersed between decoders and encoders.

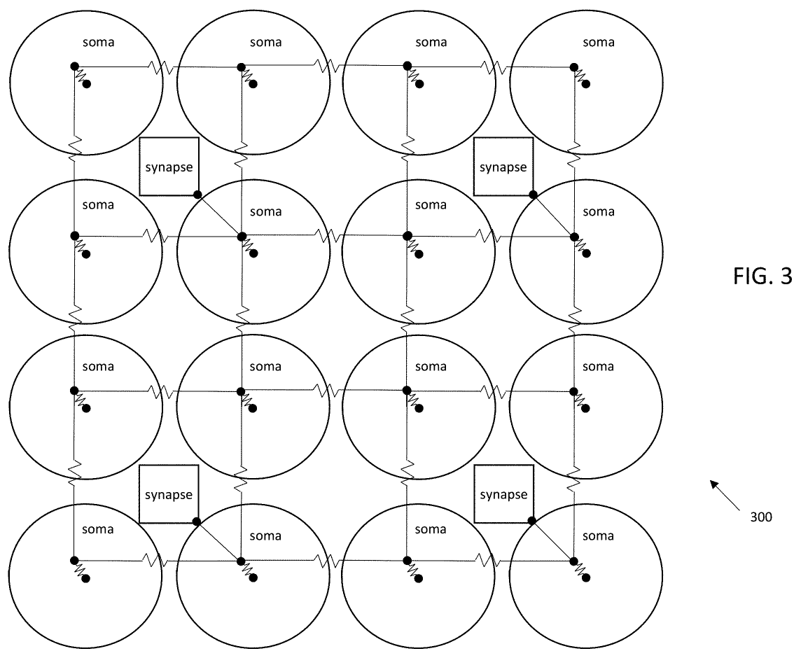

FIG. 3 is a graphical representation of one exemplary embodiment of a spiking neural network 300, in accordance with the various principles described herein. As shown therein, the exemplary spiking neural network includes a tessellated processing fabric composed of “somas”, “synapses”, and “diffusers” (represented by a network of “resistors”). As shown therein, each “tile” of the tessellated processing fabric includes four (4) somas that are connected to a common synapse; each synapse is connected to the other somas via the diffuser.

While the illustrated embodiment, is shown with a specific tessellation and/or combination of elements, artisans of ordinary skill in the related arts given the contents of the present disclosure will readily appreciate that other tessellations and/or combinations may be substituted with equivalent success. For example, other implementations may use a 1:1 (direct), 2:1 or 1:2 (paired), 3:1 or 1:3, 1:4, and/or any other N:M mapping of somas to synapses. Similarly, while the present diffuser is shown with a “square” grid, other polygon-based connectivity may be used with equivalent success (e.g., triangular, rectangular, pentagonal, hexagonal, and/or any combination of polygons (e.g., hexagons and pentagons in a “soccer ball” patterning)).

Additionally, while the processing fabric 300 of FIG. 3 is a two-dimensional tessellated pattern of repeating geometric configuration, artisans of ordinary skill in the related arts given the contents of the present disclosure will readily appreciate that tessellated, non-tessellated and/or irregular layering in any number of dimensions may be substituted with equivalent success. For example, neuromorphic fabrics may be constructed by layering multiple two-layer fabrics into a three-dimensional construction.

In one exemplary embodiment, a “soma” includes one or more analog circuits that are configured to generate spike signaling based on a value. In one such exemplary variant, the value is represented by electrical current. In one exemplary variant, the soma is configured to receive a first value that corresponds to a specific input spiking rate and/or to generate a second value that corresponds to a specific output spiking rate. In some such variants, the first and second value are integer values.

In one exemplary embodiment, the input spiking rate and output spiking rate is based on a dynamically configurable relationship. For example, the dynamically configurable relationship may be based on mathematical models of biological neurons that can be configured at runtime and/or during runtime. In other embodiments, the input spiking rate and output spiking rate is based on a fixed relationship. For example, the fixed relationship may be part of a hardened configuration (e.g., so as to implement known functionality).

In one exemplary embodiment, a “soma” includes one or more analog-to-digital conversion (ADC) components configured to generate spiking signaling within a digital domain based on one or more values. In one exemplary embodiment, the soma generates spike signaling having a frequency that is directly based on one or more values provided by a synapse. In other embodiments, the soma generates spike signaling having a pulse density that is directly based on one or more values provided by a synapse. Still other embodiments, may generate spike signaling having a pulse width, pulse amplitude, or any number of other spike signaling techniques.

In one exemplary embodiment, a “synapse” includes one or more digital-to-analog conversion (DAC) components configured to convert spiking signaling in the digital domain into one or more values (e.g., current) in the analog domain. In one exemplary embodiment, the synapse receives spike signaling having a frequency that is converted into a one or more current signals that can be provided to a soma. In other embodiments, the synapse may convert spike signaling having a pulse density, pulse width, pulse amplitude, or any number of other spike signaling techniques into the aforementioned values for provision to the soma.

In one exemplary embodiment, the ADC and/or DAC conversion between spiking rates and values may be based on a dynamically configurable relationship. For example, the dynamically configurable relationship may enable spiking rates to be accentuated or attenuated. More directly, a synapse may be dynamically configured to receive/generate a greater or fewer number of spikes corresponding to the range of values used by the soma. In other words, the synapse may emulate a more or less sensitive connectivity between somas. In other embodiments, the ADC and/or DAC conversion is a fixed configuration.

In one exemplary embodiment, a “diffuser” includes one or more diffusion elements that couple each synapse to one or more somas and/or synapses. In one exemplary variant, the diffusion elements are characterized by resistance that attenuates values (current) as a function of spatial separation. In other variants, the diffusion elements may be characterized by active components that actively amplify signal values (current) as a function of spatial separation. While the foregoing diffuser is presented within the context of spatial separation, artisans of ordinary skill in the related arts will appreciate given the contents of the present disclosure that other parameters may be substituted with equivalent success. For example, the diffuser may attenuate/amplify signals based on temporal separation, parametric separation, and/or any number of other schemes.

In one exemplary embodiment, the diffuser includes one or more transistors which can be actively biased to increase or decrease their pass through conductance. In some cases, the transistors may be entirely enabled or disabled so as to isolate (cut-off) one synapse from another synapse or soma. In one exemplary variant, the entire diffuser fabric is biased with a common bias voltage. In other variants, various portions of the diffuser fabric may be selectively biased with different voltages. Artisans of ordinary skill in the related arts given the contents of the present disclosure will readily appreciate that other active components may be substituted with equivalent success; other common examples of active components include without limitation e.g.,: diodes, memristors, field effect transistors (FET), bi-polar junction transistors (BJT), etc.

In other embodiments, the diffuser includes one or more passive components that have a fixed impedance. Common examples of such passive components include without limitation e.g., resistors, capacitors, and/or inductors. Moreover, various other implementations may be based on a hybrid configuration of active and passive components. For example, some implementations may use resistive networks to reduce overall cost, with some interspersed MOSFETs to selectively isolate portions of the diffuser from other portions.

### Existing Routing Techniques

A brief discussion of existing neuromorphic physical routing and logical addressing techniques may be useful for illustrating both the deficiencies of the prior art, and the benefits of the principles described herein. As previously alluded to, existing physical routing and logical addressing mechanisms either use low-overhead grids with one (1) or two (2) shared wires per row or column (such as is commonly used in memories (e.g., random access memories (RAM)) or high-overhead “meshes” with many wires connecting neighboring nodes.

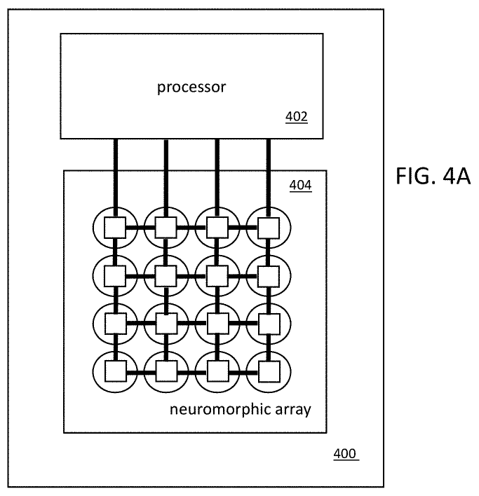

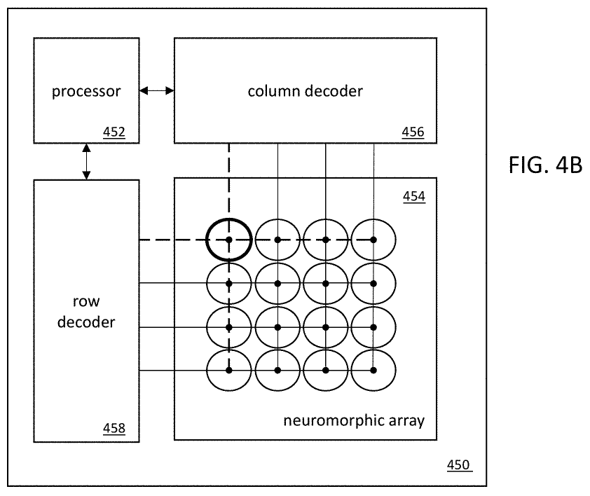

FIG. 4A is a logical block diagram of a high-overhead router scheme. In the illustrated implementation, the neuromorphic chip 400 includes a processor 402, and a neuromorphic array 404 of “nodes” (e.g., computational primitives such as the aforementioned somas and synapses). In the full mesh configuration, each node of a neuromorphic array 404 system is directly connected via a dedicated link to its neighbors. Full mesh networks enable very high bandwidth links between the processor 402 and any of the nodes. Moreover, each node can transfer data of arbitrary length and at very high speed, since there is no contention due to resource sharing (other than the processor's own bandwidth limitations). Full mesh connectivity easily accommodates neuromorphic computing loads (which are typically limited to only a spike and/or weight value); but full mesh connectivity may be underutilized in most (if not all) neuromorphic computing applications.

Full mesh connectivity uses individualized, sophisticated physical routing and logical addressing circuitry. For example, in the illustrated example, logical addressing circuitry (squares) connect the clients via dedicated busses (thick lines). Physical routing and logical addressing circuitry costs can be quantified as a function of N clients; i.e., for the illustrated system of FIG. 4A, sixteen (16) clients require sixteen (16) instances of physical routing and logical addressing circuitry. In other words, physical routing and logical addressing both scale according to O(N) for N clients.

As a brief aside, so-called “Big O” notation categorizes the limiting behavior of system complexity as a function of scale (approaching infinity). Within the context of the present disclosure Big O notation refers to complexity as a function of physical routing resources and logical addressing; physical routing resources and logical addressing that does not change as a function of scale do not affect the Big O categorization. Similarly, Big O notation does not denote actual complexity. In fact, for some N, a O(√N) scheme may be more complex than a O(N) scheme. For reasons that are made apparent hereinafter, Big O notation is a useful estimate of system complexity as a function of size but it does not provide the complete picture.

FIG. 4B is a logical block diagram of a neuromorphic chip 450 that exemplifies a low-overhead “grid-based” router scheme. In the illustrated implementation, the neuromorphic chip 450 includes a processor 452, a neuromorphic array 454, a row decoder 458, and a column decoder 456. The nodes of the neuromorphic array 454 are tiled in a two-dimensional (2D) array that share row and column wires. The combination of the row decoder 458 and the column decoder 456 can be used to uniquely identify any element of the neuromorphic array 454. For example, in order to access an element, the row and column decoder assert their corresponding row and column (e.g., the dashed row and column).

The grid-based addressing scheme uses much less wiring than a full mesh because the nodes share wires (represented with thin lines) and simpler logical addressing (the absence of a logical address circuitry). Under the grid-based addressing scheme, N clients can be serviced with physical routing and logical addressing resources that scale with the square-root of N; i.e., for the illustrated system of FIG. 4B, sixteen (16) clients require four (4) instances of row and column physical routing and logical addressing circuitry.

Current neuromorphic computing arrays already number in the thousands of clients (e.g., 4096 somas with 1024 synapses). However, neuromorphic computing will continue to grow in complexity; thus, routing technologies must also scale to support client nodes numbering in the tens of thousands, hundreds of thousands, etc. For such large-scale networks, full mesh networks are impractical. Grid-based routing offers significant physical routing and logical addressing savings for large scale systems. However, grid-based addressing can suffer from physical effects and/or manufacturing issues. For example, using shared row and column address wires may require tight timing to compensate physical effects such as charge relaxation (significant voltage differences over the length of a wire). In particular, nodes that are closer to the row and column decoders will experience minimal charge relaxation, whereas nodes that are farther away may experience substantial signal attenuation and/or timing. Consequently, even though grid-based arrays provide advantages of scale, they remain problematic for current as well as future neuromorphic computing arrays.

### Exemplary Tree-based Physical Routing Complexity

In general, a k-ary tree that is balanced has

$$\frac{N - 1}{k - 1}$$

nodes and logₖ N levels. For example, an evenly weighted binary tree (2-ary) structure would have N-1 nodes, whereas a 4-ary tree has

$$\frac{N - 1}{3}$$

nodes. More directly, a 4-ary tree has a third of the node-count and half the number of levels for a comparable binary tree (2-ary). From a performance perspective, a 4-ary tree network halves latency, and doubles the un-pipelined throughput, relative to a binary tree (2-ary); however binary trees may be preferred for other reasons (e.g., simplicity of logical addressing, etc.) Though the prior discussion addresses balanced trees, artisans of ordinary skill in the related arts will readily appreciate that unbalanced trees may have less efficient distributions, but may be preferable for other reasons (e.g., where certain clients are more active than others, etc.)

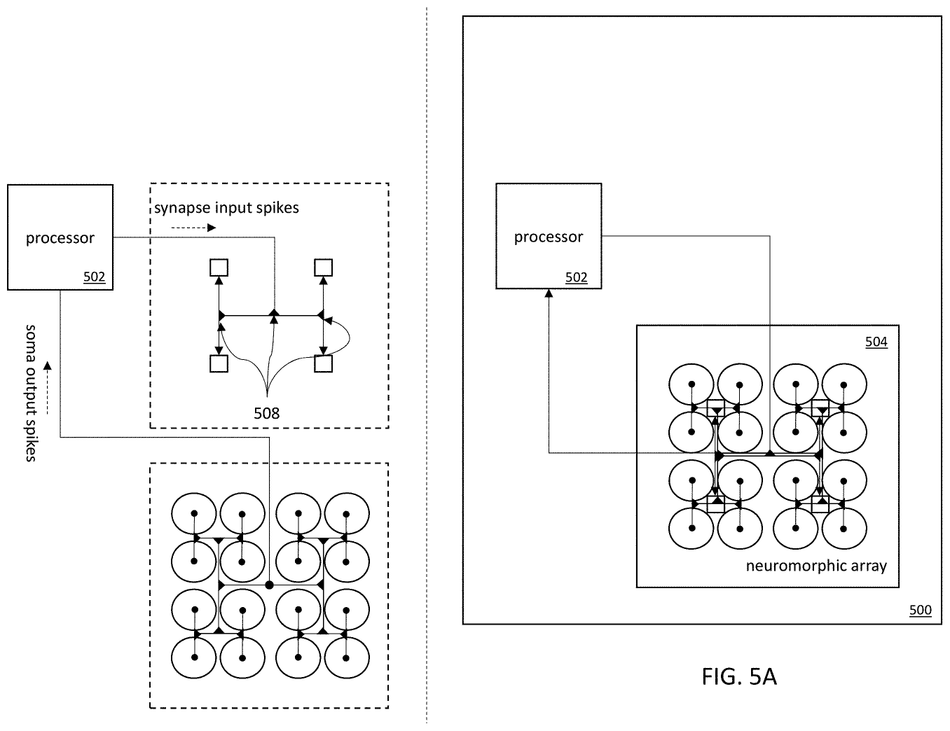

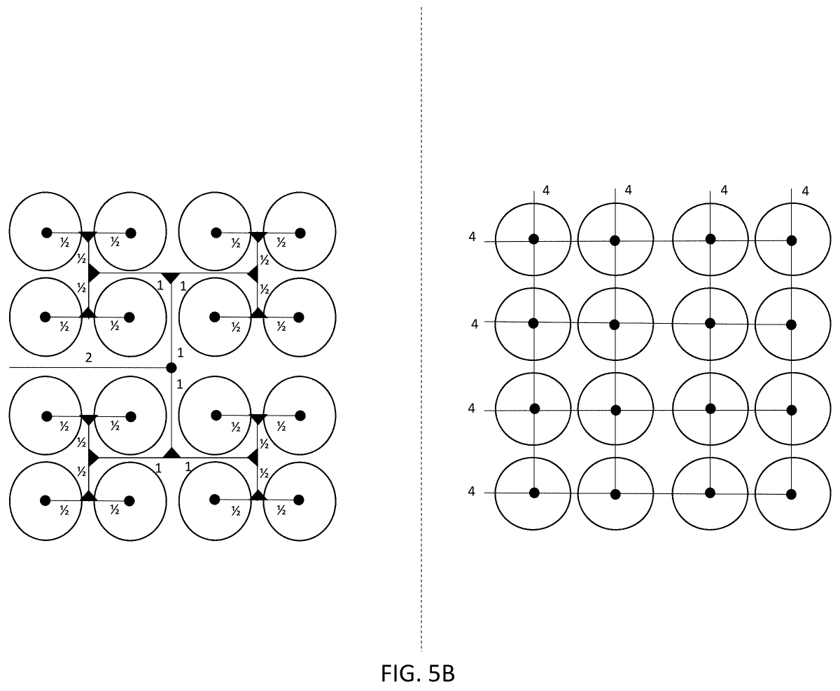

FIG. 5A is a logical block diagram of an exemplary tree-based neuromorphic system 500. As shown therein, the tree based neuromorphic system 500 includes a processor 502 that is coupled to the neuromorphic array 504 via a tree network. The tree network routes messaging according to a tree topology via a network of tree switches 508. In one exemplary embodiment, two (2) overlaid H-trees enable access to two different types of clients. Specifically, a first “receive” or “upstream” H-tree enables a number of synapses to receive input from a processor 502 via an H-tree router composed of a first set of H-tree routing switches 508. A second “transmit” or “downstream” H-tree router enables a number of somas to transmit spikes to a processor 502 via a second set of H-tree routing switches 508. The first and second H-trees are shown both separated and overlaid. In one optimized variant, the transmit and receive H-trees are characterized with different circuitry (e.g., different transistor combinations) corresponding to their differences in functionality (e.g., transmit and receive). In a related variant, the H-trees may further use different circuits for the tree routing switches 508 at the “leaves”, “branches”, and/or “root” (which do not need to route packets further). While the illustrated example uses a 1:4 ratio of synapses to somas, any N-to-M scheme may be substituted with equivalent success by artisans of ordinary skill, given the contents of the present disclosure.

Each H-tree consists of a geometric pattern that alternates between horizontal and vertical orientations, halving the routing segment length at each fractal iteration relative to the previous fractal iteration, while doubling the routing segment length at every other fractal iteration. The infinite series for tree width (Wₜ) is given by EQN 1:

$${W}_{t} = \frac{1}{2} ( N + \frac{N}{2} ) + 1 ( \frac{N}{8} + \frac{N}{2} ) + 2 ( \frac{N}{16} + \frac{N}{32} ) … = \frac{3}{2} N \qquad EQN 1$$

In contrast, the width of a grid (W_{g}) is given by EQN 2:

W=2N EQN 2

Mathematically in the limit of large N, the difference in physical routing resources between equivalent link-width H-trees and grid arrays is given by EQN 3:

$${W}_{t} = \frac{3}{4} {W}_{g} \qquad EQN 3$$

For small N, the difference is more pronounced. FIG. 5B illustrates one such side-by-side comparison of an H-tree and grid array of equal link-widths. As shown therein, the H-tree requires 37.5% less physical routing resources than a grid array of equal link-widths. Notably, the H-tree segments are longer closer to the “root” of the tree; however, the roots and branches are shared for each of the “leaves”.

Even though the H-tree has fewer physical routing “wires” than a grid array, the exemplary H-tree has embedded logical addressing circuitry, which scales according to O(N) (compared to grid array addressing which scales O(√N), see discussion Existing Routing Techniques, supra).

As previously noted, exemplary variants may use different routing circuitry for the root and other intermediary switches, and the “leaves” (client nodes). In particular, leaf nodes are tailored to the specific client (e.g., soma or synapse) needs. A generalized equation to describe a total transistor count for a N-client k-ary tree having differentiable intermediary and leaf node transistor counts is given by EQN 4:

$${T}_{totk} = \frac{N - 1}{k - 1} \frac{( 1 - \frac{k}{N} ) {T}_{Ik} + ( k - 1 ) {T}_{LK}}{k - \frac{k}{N}} \qquad EQN 4$$

Where:
N=the number of clients;
k=the branching for a k-ary tree;
T_{Ik}=the transistor count for an intermediary node; and
T_{Lk}=the transistor count for a leaf node.

For reference, one exemplary implementation of an H-tree transmitter root/branch node can be constructed from 255 transistors (T_{Ik}=255), and a leaf node can be constructed from 208 transistors (T_{Lk}=208); an exemplary H-tree receiver root/branch node can be constructed from 148 transistors (T_{Ik}=148), and a leaf node can be constructed from 54 transistors (T_{Lk}=54). For comparison, an exemplary binary tree implementation of transmitter nodes may have T_{Ik}=91, and T_{Lk}=78 and an exemplary binary tree implementation of receiver nodes may have T_{Ik}=64, and T_{Lk}=30.

While the exemplary implementation is presented in the context of a 4-ary H-tree, artisans of ordinary skill in the related arts will readily appreciate that other k-ary trees (e.g., binary trees (2-ary), T-trees (3-ary), and/or higher order trees) may be substituted with equivalent success, given the contents of the present disclosure. Some implementations may be more or less constrained with regards to silicon layout, power consumption, speed, client number, etc. For example, a binary tree structure may be preferable where reduced physical routing for a number of clients is desired. Moreover, in some cases, various other non-tree structures may be used in conjunction with the tree-based routing schemes described herein. For example, some architectures may intersperse ring, star, or even daisy-chain based client topologies within a larger neuromorphic array; such additional circuitry may change the implementation considerations (e.g., more substantial leaf node circuitry may reduce the desired number of branches and vice versa).

Additionally, artisans of ordinary skill in the related arts will readily appreciate that the various analytical techniques described herein may be applied to any number of dimensions. For example, while the foregoing example of FIG. 5B was presented in the context of a 2D grid array, emerging 3D processes may use similar tree structures in three dimensions. A H-tree-like 3D structure would have wire segments along three (3) axes; i.e., the routing segment length may be halved at each fractal iteration relative to the previous fractal iteration, while doubling the routing segment length at every third fractal iteration. Consequently in the limit of large N, the difference in physical routing resources between equivalent link-width H-trees and grid arrays for a 3D context is given by EQN 5:

$${W}_{t} = \frac{7}{24} {W}_{g} \qquad EQN 5$$

The foregoing techniques for analyzing physical routing complexity are purely illustrative. Consequently, while the exemplary H-tree-based addressing scheme was selected based on the various considerations specific to one exemplary fabrication technology (e.g., 2D fabrication, transmitter/receiver transistor counts, etc.), artisans of ordinary skill in the related arts will readily appreciate given the contents of the present disclosure, that different fabrication constraints may result in other tree-based constructions or modifications/variations of the exemplary H-tree.

### Exemplary Tree-based Logical Addressing

In one exemplary embodiment, a processor communicates with a neuromorphic array via a tree router composed of a network of tree switches. The tree router sends and receives packets via the tree switches.

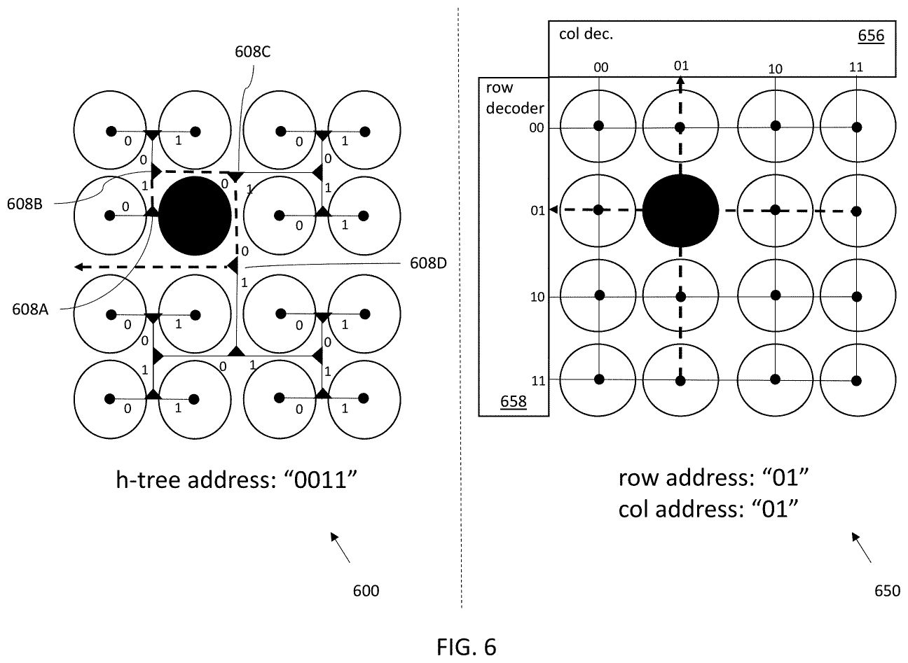

FIG. 6 provides a side-by-side comparison of logical addressing in an exemplary H-tree array 600 and a grid array 650. As shown therein, logical addressing within an H-tree is defined by a “path” through a network of tree switches 608, whereas logical addressing within a grid array is defined by the intersection of row and column coordinates. In the illustrative example of FIG. 6, a soma (darkened) is identified by the H-tree path-based address “0011”. For comparison, a corresponding soma (darkened) of the grid array is identified by the row address “01” and column address “01”.

In order to better illustrate the mechanics of path-based addressing, a short summary of the path-based address generation depicted in FIG. 6 is described. Initially, a soma (darkened) generates a spike packet (which may or may not be associated with payload data). The packet (including payload, if any) is transmitted to a first tree switch 608A. The tree switch 608A appends a path address (“1”) to the packet and forwards it to the next tree switch 608B. The second tree switch 608B appends a path address (“1”), so that the packet thus includes an address “11” (signifying both the first and the second paths). The packet is forwarded to the third tree switch 608C, and the fourth tree switch 608D, each of the tree switches performing the same process of appending path information. As shown in FIG. 6, the resulting packet includes a path-based address “0011” and payload (if any).

While not expressly shown, artisans of ordinary skill in the related arts will readily appreciate that the path-based addressing may operate in the reverse direction to provide e.g., spikes to a network of synapses. For example, a packet with the address “00” may be provided to a first tree switch. The first bit of the address (“0”) identifies the vertical path segment; the first tree switch strips the first bit, and forwards the remaining portion of the packet “0” to the identified second tree switch. The second tree switch reads the second bit of the address (“0”), strips the second bit, and forwards the remaining portion (e.g., an excitatory/inhibitory spike payload, or programming weight to the destination synapse, etc.)

One benefit of the distributed tree router structure is that each tree switch can asynchronously operate relative to the other tree switches. In other words, the distributed nature of path-based addressing is used to localize only the portion of address information to the tree switch that needs to make the corresponding decision. All other information that is extraneous to the tree switch can be ignored and passed on (e.g., to the tree switch that needs it). In effect, path-based addressing distributes networking load throughout the entire neuromorphic array in a manner analogous to a processing “pipeline”. As a practical matter, the distributed tree switches parallelize network routing within the tree and enables the neuromorphic array to route many packets simultaneously; providing much higher throughput than handling packets one at a time.

Referring now to the grid-based addressing 650, artisans of ordinary skill in the related arts will readily appreciate that only one row and column may be active at any time. More directly, a single soma can only be identified by a single unique row address and a single unique column address. Neuromorphic network elements (somas or synapses) operate simultaneously and independently; thus, grid-based arrays present significant problems where multiple somas nearly simultaneously fire. These collisions require contention-based access within the grid array and the periphery, and in order to preserve the spiking information (e.g., timing/order), a grid array must be manufactured to very high tolerances and/or compensate for physical effects (e.g., charge relaxation).

In contrast to grid-based addressing, the exemplary path-based routing greatly simplifies contention control. Multiple somas may simultaneously fire, and be routed to their corresponding tree switch. Each tree switch only needs to resolve contention between its inputs. In the exemplary H-tree embodiment of FIG. 6, each tree switch only needs to resolve between two (2) inputs.

In one exemplary embodiment, each tree switch includes a mutual exclusion circuit (mutex) that arbitrates between two (2) contending accesses. For example, an exemplary mutex may include cross-coupled NOR gates that are coupled to two (2) inputs (e.g., somas). When neither client node is inactive, the mutex is inactive. When only one client node is active, the mutex is “stable” and allows the active client node to transfer packet data via the tree switch. If the previously inactive client node attempts to access the tree switch, the mutex will “lock out” and prevent the second comer client node from interrupting the active client node's transfer. If both client nodes attempt to access the tree switch simultaneously, then the mutex is forced into a physically unstable state. The unstable mutex will eventually settle into a stable state, that selects only one of the client nodes as the “winner” of the arbitration. The winner is allowed to transfer packet data; the “loser” must wait until the winner finishes. While the exemplary embodiment is described in the context of a two (2) input mutex, higher order branching may cascade mutexes to resolve a greater number of inputs (e.g., four (4) inputs can be fed to a pair of mutex; the outputs of the pair of mutex are fed into another mutex). Mutex circuitry and other forms of hardware arbitration are well known in the existing arts and are not further described.

Referring back to FIG. 6, artisans of ordinary skill in the related arts will readily appreciate that grid-based arrays are asymmetric in that the row and column decoders are on one side of the grid array; for example, in FIG. 6, the soma at row/col address “0000” is relatively much closer than the soma at row/col address “1111”. As a result, physical effects due to grid distance may affect the soma at row/col address “1111” to a much greater extent. For example, charge relaxation may substantially attenuate and/or delay spike propagation. In the context of neuromorphic array computing, this may manifest as a mis-ordering of spiking information (e.g., spikes from the soma at row/col address “0000” may always arrive earlier than from the soma at row/col address “1111”). Manufacturing the grid array to compensate for such physical effects, or ensuring that a grid array would not be susceptible to mis-ordering may be expensive and/or impractical.

Within this context, another benefit of the exemplary path-based routing over grid-based addressing is simplified and more robust timing relative to grid-based alternatives. As previously noted, the exemplary H-tree array is a “self-similar” fractal. One such property of the self-similar fractals is that they are similar at every level (or fractal iteration), thus fractal trees are characterized by equidistant path segment lengths. For example, as illustrated in the exemplary H-tree array 600, each of the client nodes is uniquely identified by a four (4) path segment address; all path segments within the same level are equal length (e.g., the segment lengths at level 4 are all ½ a node length, the segment lengths at level 2 are all 1 node length, etc.) As a result, every client node is equidistant from the root and can be assumed to have approximately the suffer the same physical effects (i.e., physical effects are not uneven); the combination of equidistant paths and tree switch mutex ordering avoids both tight manufacturing tolerances and/or precision timing control.

### Exemplary Asynchronous Serial Link Operation

In one exemplary embodiment, each link within the exemplary neuromorphic array is an asynchronous serial link. Serial links enable constant link-width regardless of the size of the H-tree. As used herein, the term “serial signaling” refers to signaling that transmits one (1) bit of data at a time. Serial signaling may use a single rail (i.e., a common rail that transmits a one (1) when logically high and a zero (0) when logically low) or a “dual rail” (also commonly referred to as 1-of-2 signaling i.e., a rail that transmits a one (1) when logically high, and a separate rail that transmits a zero (0) when logically high).

For reference, the term “parallel signaling” refers to signaling that transmits multiple bits of data at a time; e.g., a four (4) lane parallel bus transmits four (4) bits of data. While the present disclosure is presented in the context of a single channel for serial signaling; multiple channel serial signaling (where each channel is a distinct serial link) may be substituted with equal success. Multiple channel serial signaling (which provides a multiple channels over multiple lanes) is logically distinguishable from multi-lane parallel signaling (which provides a single channel over multiple lanes), even though their physical wiring requirements may be very similar if not identical. In fact, more complex variants may be able to switch between multichannel serial and parallel operation.

As used herein, the term “link width” refers to the number of “wires”, “traces”, or other transmission medium for transacting signals. For example, a two-wire interface has a link width of two (2). A serial bus that has four (4) wires (e.g., (i) channel open/close, (ii) enable/acknowledge, (iii) asynchronous logic high, (iv) asynchronous logic low) has a link width of four (4).

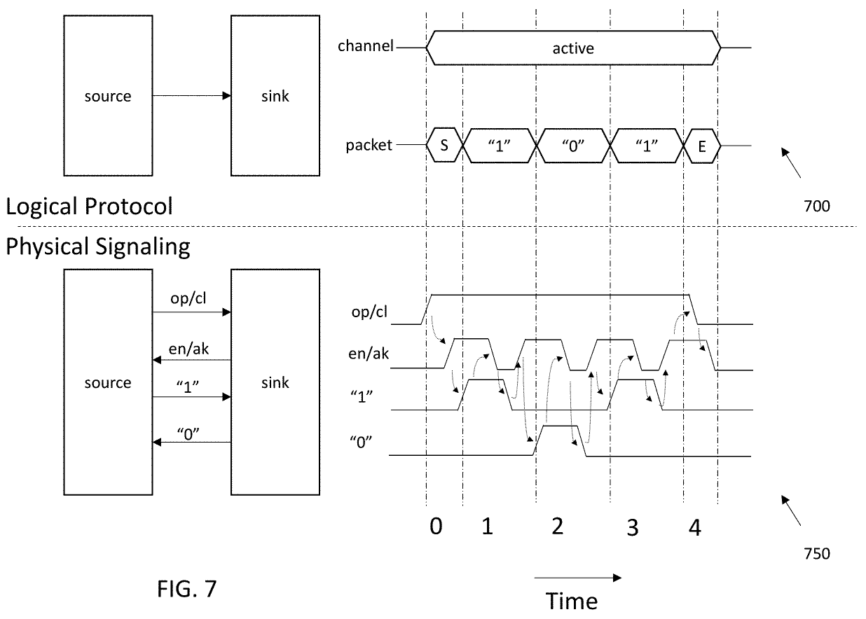

FIG. 7 is a graphical representation of an exemplary asynchronous serial handshaking protocol. The graphical representation is presented as a logical protocol 700 and a corresponding underlying physical signaling mechanism 750.

Referring now to the logical protocol 700, a source node opens a channel to the sink node. When the channel is active, packet transactions can be handled via the asynchronous serial link. When the channel is not active, no data can be transferred. In one exemplary embodiment, each source is directly connected to a sink; thus, there is no bus arbitration. For example, a first serial link connects a first soma and a second serial link connects a second soma to a two (2) input tree switch. Each of the first soma and second soma have their own serial links; thus neither soma is in direct contention for one another. However, as previously noted, the tree switch includes a mutex that will only enable/acknowledge one of the somas. The waiting soma must wait until the currently handled soma concludes (and closes its channel).

As used herein, the term “source” refers to a node, component, or other entity that transmits a data payload. As used herein, the term “sink” refers to a node, component, or other entity that receives a data payload. While the present disclosure is presented in the context of a unidirectional link, artisans of ordinary skill in the related arts will readily appreciate that the techniques and mechanisms described herein may be extended to bidirectional, multi-directional, and broadcast-based systems. For example, a bidirectional link between two (2) nodes may be implemented with an “upstream” unidirectional link (from somas to the tree router) and a “downstream” unidirectional link (from the tree router to the synapses).

As shown in the logical protocol, the logical protocol includes: (i) a start handshake that initiates communication, (ii) one or more data handshakes for each data bit, and (iii) an end handshake that terminates communication.

Referring now to the physical signaling 750, in one exemplary embodiment, the asynchronous serial link includes a four (4) wire interface. The four (4) wire interface includes: (i) channel open/close, (ii) enable/acknowledge, (iii) asynchronous logic high, (iv) asynchronous logic low.

In one exemplary embodiment, the start handshake is initiated when the source requests a channel by asserting the open/close line. The assertion of the open/close signal indicates to the sink that the source has data to transmit. The assertion of the open/close signal also transfers transactional control to the sink (i.e., the source must wait for the sink to respond). When the sink is ready to start the data transfer, the sink asserts the enable/acknowledge signal. Assertion of the enable/acknowledge signal terminates the start handshake and transfers transactional control back to the source for the first data handshake.

In one exemplary embodiment, the data handshake uses dual rail signaling (also referred to as “1-of-2” signaling) to transmit data bits and sequentially advance to the next data bit in response to enable/acknowledge signal assertions. The sink acknowledges the data bit value using enable/acknowledge signal de-assertions. For example, in order to transfer a “1”, the source asserts the “1” signal (vesting transaction control in the sink). When the sink has received the “1” signal, it can de-assert the enable/acknowledge signal (vesting transaction control back to the source). The source can de-assert its “1” signal (returning the dual rail signaling to a “null” data state; the source may then advance to the next data bit); control is returned to the sink. When the sink is ready for the next data bit, it asserts then enable/acknowledge signal.

As a brief aside, synchronous signaling often uses a single rail and a clock to “clock” data bits; i.e., the voltage (logic high or logic low) of the data line at each clock edge corresponds to a bit of data. In contrast, dual rail signaling is used to unambiguously identify the next data bit value without a clock. The rail corresponding to “1” is only asserted when the data is “1” and similarly, the rail corresponding to “0” is only asserted when data is “0”. When neither rail is asserted, then the sink must continue to wait. In most dual rail signaling implementations, both rails cannot be asserted (a dual assertion is treated as an invalid state).

In one exemplary embodiment, the end handshake closes the channel when the source has no more data to send. Specifically, when the sink asserts an enable/acknowledge, rather than sending data, the source can de-assert the open/close signal to indicate that the packet end. Thereafter, the sink can acknowledge and close the channel by de-asserting the enable/acknowledge signal.

The exemplary asynchronous handshaking protocol enables a processor to communicate with a very large neuromorphic array of compute primitives without any shared timing for the system; in other words, the processor, tree router composed of a network of tree switches, and client nodes (synapses and somas) do not need a common clock to operate. Asynchronous handshaking allows for much more flexibility for manufacturing and operation. For example, the number of client nodes that can be supported is no longer limited by manufacturing tolerances and/or timing analysis; as a result, very large neuromorphic arrays can be manufactured inexpensively. Additionally, the client nodes can take as long (or as little) as is necessary to communicate (the mutex arbitration preserves client node order information); this may enable silicon processes to operate over a wider range of voltages and temperatures. Moreover, asynchronous operation simplifies other aspects of operation; for example, the aforementioned mutex circuits are relatively inexpensive to manufacture but do not provide a deterministic timeframe for when arbitration will complete (this may be problematic for synchronous protocols).

### Methods

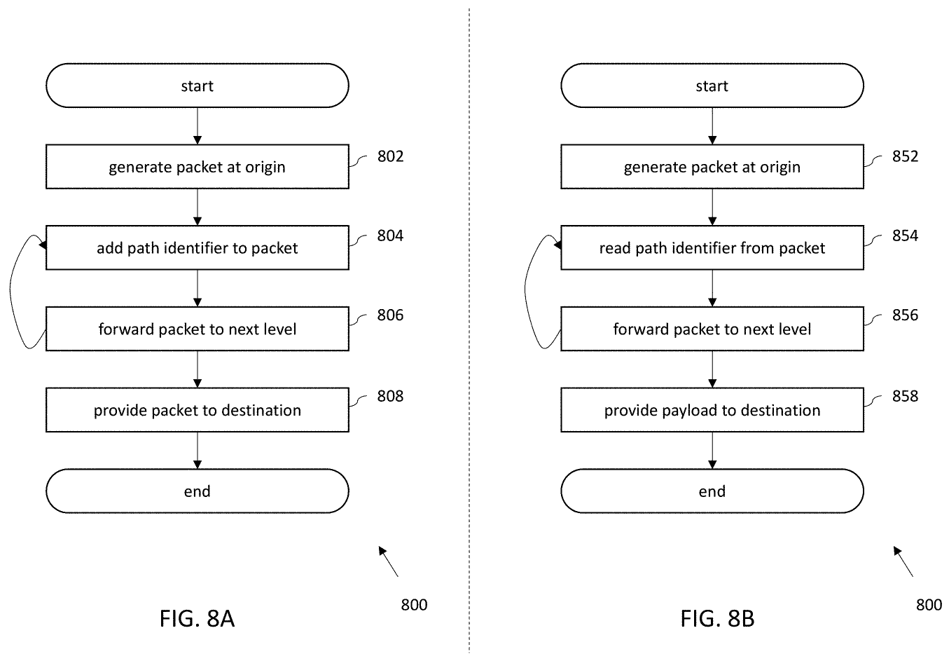

FIG. 8A is a logical flow diagram 800 of one exemplary method for receiving data from a neuromorphic array of compute primitives.

At step 802 of the method 800, a packet is generated by an origin node for transfer to a destination node via a tree network. In one exemplary embodiment, a plurality of somas generate “upstream” data packets for transfer via a tree router. In other embodiments, the origin and/or destination nodes may be other types of neuromorphic and/or processing entities. Examples of nodes may include e.g., processors, neurons, somas, synapses, switches, routers, and/or other forms of logic. For example, in a multi-processor implementation two or more processors may communicate via the tree network. In neuromorphic arrays which enable direct soma-to-soma communication, multiple somas may directly communicate with one another via the tree network.

As used herein, the term “origin” refers to a first node that transmits a data payload via one or more intermediary nodes to a “destination” node. Each connection between nodes is referred to herein as a “path segment”; the ordered sequence of path segments is referred to herein as a “path”. While the present disclosure is presented in the context of a directional path (e.g., from origin to destination), alternative embodiments may use non-directional paths (e.g., two nodes which communicate in both directions via the same path). In some cases, paths may be “reversible” (e.g., the reverse direction is the mirror of the forward direction); in other cases, paths may be non-reversible (e.g., the path cannot be traversed in the reverse direction). While the present disclosure is directed to an “acyclic” path having two end nodes, paths may be cyclic (e.g., a ring of nodes) and/or have multiple endpoints. For example, a node may split a packet into two or more packet streams, etc.

As used herein, the term “packet” refers to a formatted data structure for communication. In one embodiment, a packet includes at least a portion of an address and a payload portion. While the present disclosure has described one illustrative packet format, many different packet formats may be substituted with equivalent success. Other common examples of data that may be included within a packet include without limitation: header, footers, preambles, postambles, midambles, error detection information, format information (e.g., version information, length), priority information, type information, and/or any other data processing information.

The exemplary embodiments are presented within the context of an ordered sequence of path segment identifiers; however, other variants may use other schemes to identify paths. In one such alternative implementation, the path segment identifiers correspond to an addressable port of a node. In other embodiments, the address portion identifiers correspond to an addressable path segment. In still other embodiments, the address portion identifiers correspond to the next addressable node. Still other forms of address identification may be substituted with equal success.

In one exemplary embodiment, the address portion is dynamically constructed as the packet traverses the tree network. In other words, packets may be forwarded with only part of the path information (“partial” path information). For example, a soma that generates an upstream packet may only identify one bit of the address portion of the packet, subsequent intermediary nodes may add more bits to the address portion, culminating in the “complete” address information at the tree router. Alternative embodiments may use and/or preserve complete path information throughout the delivery process.

As used herein, the term “tree network” refers to a network characterized by a number of hierarchically nested levels, each level characterized by a number of branches.

In one exemplary embodiment, the branching is k-ary for a number of levels i.e., every level has k branches. For example, a 4-ary tree has a root that splits into four (4) branches (the first level); each branch splits into another four (4) branches (the second level), etc. Examples of k-ary trees include binary trees (2-ary), T-trees (3-ary), H-trees (4-ary), and/or any number of higher order trees.

In one exemplary embodiment, the tree network is a fractal tree. In the exemplary embodiment, the tree topology is an “H-tree” fractal. As a brief aside, the term “fractal” refers to a topological structure that exhibits similar patterns at different levels of scale. Each level of scale is referred to herein as a “level” or a “fractal iteration.” The iterative properties of fractals are also generally referred to as “self-similarity”, “expanding symmetry”, or “unfolding symmetry.” More directly, the self-similarity property of fractals lends them particularly well to recursion and/or recursive techniques. Within the computing arts, the term “recursion” refers to an object, structure, or process that can be defined in terms of itself or by its type, usually within a limited scope (e.g., within a terminating loop structure).

In one embodiment, the tree network supports a plurality of compute primitives. Within the context of neuromorphic computing, a compute primitive is circuitry that mimics the behavior of a neuron in whole or in part. As previously described, compute primitives include somas, synapses, neurons, dendrites, and/or any other neural mechanism. Compute primitives may be physically implemented as an array of circuitry, or virtualized in whole or in part via software. For example, in one exemplary embodiment, a neuromorphic chip may include a digital processor that dynamically weights, accumulates, and/or performs thresholding, and an array of analog neuromorphic circuitry that are split into somas (that output spikes to the processor) and synapses (that receive spikes from the processor). The synapses are coupled to the somas via shared dendrites. In aggregate, the combination of processor, somas, dendrites, and synapses can be used to emulate large spiking neural networks. In alternative embodiments, a neuromorphic chip may include multiple processors and/or multiple neuromorphic arrays performing a variety of analog and/or digital computing to emulate spiking neural network behavior.

In one exemplary embodiment, a partial packet is generated when a soma has been sufficiently excited by its connected synapses. The partial packet may or may not include a payload (e.g., the presence of a spike may be inferred from the presence of the packet). For example, the packet may be a bit corresponding to the path segment of the soma that has fired (i.e., a single bit of the path-based address). In other embodiments, the partial packet may include a payload. Examples of such payloads may include e.g., a number of spikes (e.g., a soma may indicate more or less intensity as multiple spikes), a value representing a virtualized intensity or frequency of spikes (e.g., a virtualized soma or equivalent may use logical values to convey activity (rather than spikes which are present or not present)).

Moreover, while the present disclosure is primarily described in the context of neuromorphic operation, artisans of ordinary skill in the related arts will recognize that a variety of non-operational contexts may also be used to communicate with the nodes of the neuromorphic array. For example, a soma may provide debug information and/or its neural weights via a payload. Such information may be useful to assess device operation and/or replicate desirable device behaviors. In other cases, a soma may be tested for functionality and/or appropriate behavior (e.g., manufacturing test, compliance, etc.)

Referring back to FIG. 8A, for each level of the tree network between the origin node and the destination node, a corresponding path identifier is added to the packet (step 804), and the packet is propagated to the next level of the tree network (step 806).

In one exemplary embodiment, a packet transmission is propagated from the client nodes (somas) upstream through the tree router composed of tree switches to the root. At each level of the tree network, the corresponding tree switch adds a path segment identifier to the address portion of the partial packet to identify the path segment that the packet was received from. For example, a tree switch may have two (2) input ports, and one (1) output port. When a data packet is received on a first input port, the address portion may be updated with a “0” and forwarded upstream; when a data packet is received on a second input port, the address portion may be updated with a “1” and forwarded upstream. In this manner, the complete packet is received at the processor with a complete record of the ordered sequence of path segments to the originating soma. In one exemplary embodiment, each path of the tree network is an asynchronous link.

In one exemplary embodiment, packet propagation is performed via serial signaling. In one such variant, the serial link is a single channel. In other variants, the serial link may have multiple channels. In alternative embodiments, each path of the tree network may be a parallel link that includes multiple lanes. In some variants, the parallel link may support multiple channels. In some variants, links may be configured as a serial link, a parallel link, or some hybrid thereof.

While the embodiments described herein forward packets without modification, artisans of ordinary skill in the related arts will readily appreciate that packet propagation may include additional processing. For example, packet propagation may include error detection, forward error correction, parity checking, thresholding, encryption/decryption, scrambling/descrambling, and/or any number of other packet processing techniques.

In one embodiment, the propagation includes link arbitration signaling. As used herein, the term “arbitration” refers to the process by which a shared resource is allocated to multiple nodes that contend for access. In one exemplary embodiment, link arbitration signaling is performed by mutual exclusion (mutex) circuits based on channel open/close signaling. A node that has successfully opened a channel can use the channel to send (and/or receive) one or more transactions until it relinquishes the channel (by closing it).

In alternative embodiments, link arbitration may be based on request/grant signaling. In still other embodiments, link arbitration may be based on fairness schemes (e.g., round robin, weighted round robin, etc.). Still other techniques for contention-based access and/or contention-less access schemes can be substituted by artisans of ordinary skill in the related arts, given the contents of the present disclosure.

In one embodiment, the source and sink operate asynchronously. As used herein, the term “asynchronous” refers to signaling that is performed without reference to time. For example, asynchronous signaling may use express acknowledgement and enablement to proceed rather than e.g., the passage of time. In contrast, the term “synchronous” refers to signaling that has a common time reference that is shared between at least the transmitter and receiver of the synchronous signaling. For example, synchronous signaling may use a clock signal that identifies when data signals are ready to be read.

In one embodiment, the asynchronous link includes handshaking signaling. As used herein, the terms “handshake” and “handshaking” refer to a signaling protocol between multiple nodes that explicitly vests control of a transaction in one node (e.g., the source or sink). Nodes that are not in current possession of transaction control must wait. In one exemplary variant, the handshaking signaling includes an enable and/or an acknowledgement signal. The enable signal indicates that a receiver is ready to receive data (and transfers control to the transmitter); the acknowledgment signal indicates that a receiver has received data (and assumes control from the transmitter). Other common schemes for controlling transaction between nodes may be substituted with equivalent success. For example, various signaling schemes may use e.g., ready to send (RTS), clear to send (CTS), enable, disable, ready, etc.

In one exemplary embodiment, the handshake protocol may further incorporate data signaling. For example, a transmitter may send data bits when enabled, and await acknowledgement before sending the next data bit. In alternative embodiments, the handshake protocol may rely on express handshaking; e.g., the transmitter may drive data lines and e.g., provide an enable when the data bits may be read. Still other embodiments may use other schemes for identifying data (e.g., a clocking signal for synchronous embodiments, etc.)

At step 808 of the method 800, the packet is provided to the destination node. In one exemplary embodiment, the destination is a processor connected to the root of the distributed tree router (composed of tree switches). In alternative embodiments, the destination node may be one or more processors coupled to one or more distributed tree routers. For example, a single neuromorphic array may be shared with a multiprocessor system. Still other implementations may use a first neuromorphic array of e.g., somas with a first processor, and a second neuromorphic array of e.g., synapses with a second processor. In still other alternative embodiments, the destination node may be another client node of the neuromorphic array (e.g., another soma or another synapse). More generally, artisans of ordinary skill in the related arts will readily appreciate that the techniques described herein may be used for packet delivery within any number of different “intermediate” complexity networks.

FIG. 8B is a logical flow diagram 850 of one exemplary method for transmitting data into a neuromorphic array of compute primitives.

At step 852 of the method 850, a packet is generated by an origin node for transfer to a destination node via a tree network. In one exemplary embodiment, a processor generates “downstream” data packets for transfer via a tree router to a plurality of synapses. As previously alluded to, data packets transmitted by the processor in the downstream direction include the complete path.

In one exemplary embodiment, path segment identifiers are configured to be read (and removed) from the address portion by tree switches to identify the path segment that the packet should be forwarded to, as the packets are propagated down the tree. As a result, the destination node (e.g., a soma or a synapse) only receives the payload (if any). Alternative embodiments may propagate the complete address (without deprecation) e.g., to assist in routing redundancy and/or re-routing. For example, more complicated tree topologies may support redundant connectivity; tree switches may be able to redirect a packet via a redundant branch in the event of a primary branch failure.

In one exemplary embodiment, the payload may include spiking information. For example, in one such variant, the payload may include information that further specifies whether the spike is inhibitory or excitatory. Additionally, while the present disclosure is primarily described in the context of neuromorphic operation, artisans of ordinary skill in the related arts will recognize that the downstream path may be used to program and/or configure the neuromorphic array for operation. For example, a processor may assign neural weights via a payload, enable or disable connectivity (e.g., by disabling tree switches, somas, synapses, and/or portions of the diffuser (dendritic connectivity)) via payload. For example, in some cases, a large H-tree array (e.g., 4096 nodes) may be reduced in size by disabling an entire level of the H-tree (to e.g., 1024 nodes) in order to reduce power, reduce arbitration complexity, etc. One such implementation may affect a reduction in size by e.g., disabling level(s) of tree switches and/or changing synapse-to-soma connectivity via shared dendrite connectivity. Still other configuration and/or non-operational input to the neuromorphic array may be substituted by artisans of ordinary skill given the contents of the present disclosure.

Referring back to FIG. 8B, for each level of the tree network between the origin node and the destination node, a corresponding path identifier is read from the packet (step 854), and the packet is forwarded to the next level of the tree network based on the read value (step 856).

In one exemplary embodiment, a packet transmission is propagated to the client nodes (synapses) downstream through the tree network via tree switches from the root of the tree. At each level of the tree network, the corresponding tree switch reads (and removes, or “strips”) a path segment identifier from the address portion of the packet to identify the path segment that the packet should be forwarded to. For example, a tree switch may have two (2) output ports, and one (1) input port. When a data packet is received on the input port, if the read address bit is a “0” then the remaining portion of the packet is forwarded via a first output port; otherwise if the read address bit is a “1” then the remaining portion of the packet is forwarded via the second output port.

At step 858 of the method 850, the packet is provided to the destination node. In one exemplary embodiment, the destination node is a client node (e.g., synapse, soma, etc.) located at a “leaf” of the tree network. In alternative embodiments, the destination node may be an intermediary node (e.g., a tree switch).

While the foregoing discussion of FIGS. 8A and 8B are presented in the contest of transmitting and receiving data to or from a neuromorphic array, artisans of ordinary skill in the related arts will readily appreciate that the principles described therein may be applied with equivalent success to inter-array (between multiple neuromorphic arrays) and/or intra-array (within a single neuromorphic array) transmissions. Moreover, the various principles described herein may be used in any network characterized by intermediate complexity (i.e., very large scale arrays of independent nodes that share limited control and/or data communications).

### Exemplary Apparatus

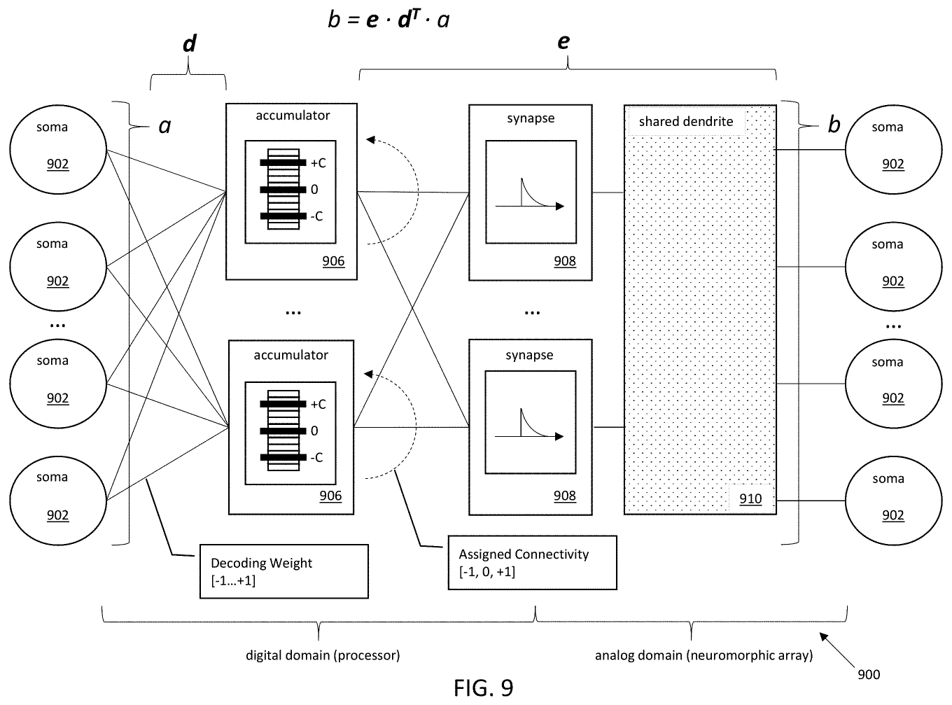

Referring now to FIG. 9, a logical block diagram of one exemplary embodiment of a spiking neural network is illustrated. While the logical block diagram is shown with signal flow from left-to-right, the flow is purely illustrative; in some implementations, the spiking signaling may return to its originating ensemble and/or soma (i.e., wrap-around).

In one exemplary embodiment, the spiking neural network 900 includes a digital computing substrate that combines somas 902 emulating spiking neuron functionality with synapses 908 that generate currents for distribution via an analog diffuser 910 (shared dendritic network) to other somas 902.

In one exemplary embodiment, computations are mapped onto the spiking neural network 900 by using an exemplary Neural Engineering Framework (NEF) synthesis tool. During operation, the NEF synthesis assigns encoding and decoding vectors to various ensembles. As previously noted, encoding vectors define how a vector of continuous signals is encoded into an ensemble's spiking activity. Decoding vectors define how a mathematical transformation of the vector is decoded from an ensemble's spiking activity. This transformation may be performed in a single step by combining decoding and encoding vectors to obtain synaptic weights that connect one ensemble directly to another and/or back to itself (for a dynamic transformation). This transformation may also be performed in multiple steps according to the aforementioned factoring property of matrix operations.

The illustrated mixed analog-digital substrate of FIG. 9 includes first-to-second and second-to-third layer weights defined by decoding vectors (d) and encoding vectors (e), respectively. The mixed analog-digital substrate of FIG. 9 leverages the benefits of thresholding accumulators 906 and the shared dendrite diffuser 910 to cut memory, computation, and communication resources by an order-of-magnitude. These advantages enable implementations of spiking neural networks with millions of neurons and billions of synaptic connections in real-time using milliwatts of power.

In one exemplary embodiment, a transformation of a vector of continuous signals is decoded from an ensemble's spike activity by weighting a decoding vector (d) assigned to each soma 902 by its spike rate value and summing the results across the ensemble. This operation is performed in the digital domain on spiking inputs to the thresholding accumulators 906. The resulting vector is assigned connectivity to one or more synapses 908, and encoded for the next ensemble's spike activity by taking the resulting vector's inner-product with encoding vectors (e) assigned to that ensemble's neurons via the assigned connectivity. Specifically, the decoding vectors define weights between the first and the second layers (the somas 902 and the thresholding accumulators 906) while encoding tap-weights define connectivity between the second and third layers (the synapses 908 and the shared dendrite 910).

In one exemplary embodiment, the decoding weights are granular weights which may take on a range of values. For example, decoding weights may be chosen or assigned from a range of values. In one such implementation, the range of values may span positive and negative ranges. In one exemplary variant, the decoding weights are assigned to values within the range of +1 to −1.

In one exemplary embodiment, connectivity is assigned between the accumulator(s) 906 and the synapse(s) 908. In one exemplary variant, connectivity may be present (+1), not present (0), or inhibitory (−1). Various other implementations may use other schemes, including e.g., ranges of values, etc. Other schemes for decoding and/or connectivity will be readily appreciated by artisans of ordinary skill given the contents of the present disclosure.

In one exemplary embodiment, decoding vectors are chosen to closely approximate the desired transformation by minimizing an error metric. For example, one such metric may include e.g., the mean squared-error. Other embodiments may choose decoding vectors based on a number of other considerations including without limitation: accuracy, power consumption, memory consumption, computational complexity, structural complexity, and/or any number of other practical considerations.

In one exemplary embodiment, encoding vectors may be chosen randomly e.g., from a uniform distribution on a D-dimensional unit hypersphere's surface. In other embodiments, encoding vectors may be assigned based on specific properties and/or connectivity considerations. For example, certain encoding vectors may be selected based on known properties of the shared dendritic fabric. Artisans of ordinary skill in the related arts will readily appreciate given the contents of the present disclosure that decoding and encoding vectors may be chosen based on a variety of other considerations including without limitation e.g.,: desired error rates, distribution topologies, power consumption, processing complexity, spatial topology, and/or any number of other design specific considerations.

One exemplary implementation is described within an asymmetric hardware design language Communicating Hardware Processes (CHP), and is provided in APPENDIX A.

It will be recognized that while certain embodiments of the present disclosure are described in terms of a specific sequence of steps of a method, these descriptions are only illustrative of the broader methods described herein, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure and claimed herein.

While the above detailed description has shown, described, and pointed out novel features as applied to various embodiments, it will be understood that various omissions, substitutions, and changes in the form and details of the device or process illustrated may be made by those skilled in the art without departing from principles described herein. The foregoing description is of the best mode presently contemplated. This description is in no way meant to be limiting, but rather should be taken as illustrative of the general principles described herein. The scope of the disclosure should be determined with reference to the claims.

What is claimed is:

1. A neuromorphic apparatus, comprising:
a node array comprising a plurality of switching nodes and a plurality of computation nodes;
where each switching node of the plurality of switching nodes has a plurality of addressable ports and the plurality of switching nodes are hierarchically nested;
where each computation nodes of the plurality of computation nodes is addressable with a hierarchically nested set of addressable ports;
a processor;
a non-transitory computer readable medium comprising a plurality of instructions, the plurality of instructions configured to, when executed by the processor, cause the processor to:
generate a first packet comprising a first plurality of addresses;
provide the first packet to the node array; and
where each address of the first plurality of addresses identifies a corresponding addressable port from a first hierarchically nested set of addressable ports.

2. The neuromorphic apparatus of claim 1, where the first packet further comprises a neuromorphic weight for a first computation nodes that is addressable with the first hierarchically nested set of addressable ports.

3. The neuromorphic apparatus of claim 1, where the first packet further comprises an exciting or inhibiting spike for a first computation nodes that is addressable with the first hierarchically nested set of addressable ports.

4. The neuromorphic apparatus of claim 1, where each switching node of the plurality of switching nodes is configured to:
responsive to receiving a packet:
identify an addressable port from an address of a plurality of addresses;
remove the address from the plurality of addresses; and
forward the packet to a switching node or a computation node coupled to the addressable port.

5. The neuromorphic apparatus of claim 1, where the plurality of instructions is further configured to, when executed by the processor, cause the processor to:
receive a second packet comprising a second plurality of addresses;
where each address of the second plurality of addresses identifies a corresponding addressable port from a second hierarchically nested set of addressable ports; and
where the second packet indicates a spike for a second computational node that is addressable with the second hierarchically nested set of addressable ports.

6. The neuromorphic apparatus of claim 1, where the plurality of switching nodes are hierarchically nested in a fractal topology.

7. The neuromorphic apparatus of claim 6, where the fractal topology is a H-tree.

8. The neuromorphic apparatus of claim 1, where the plurality of switching nodes of the node array are coupled via a plurality of serial links.

9. The neuromorphic apparatus of claim 8, where the plurality of serial links are characterized by asynchronous dual rail signaling.

10. A method for asynchronous handshake-based packet transfer within an array of nodes, comprising:
responsive to receiving a packet:
splitting the packet into an address portion and a forwarding portion;
identifying an addressable port from a plurality of addressable ports based on the address portion;
arbitrating for control of the addressable port;
for each bit of the forwarding portion:
transmitting the bit responsive to an enable signal;
incrementing to a next bit responsive to an acknowledge signal; and
releasing control of the addressable port after a last bit of the forwarding portion has been transmitted.

11. The method of claim 10, where transmitting the bit responsive to the enable signal comprises dual rail signaling.

12. The method of claim 10, where the packet is received from another node of the array of nodes.

13. The method of claim 10, where transmitting the bit responsive to the enable signal comprises transmitting to another node of the array of nodes.

14. The method of claim 13, where the another node of the array of nodes comprises a fractal tree switching node.

15. The method of claim 13, where the another node of the array of nodes comprises a computational node.

16. A method for addressing a packet to a computational node of a tree network, where the tree network comprises a plurality of computational node addressable via a plurality of switching nodes, comprising:
generating a payload for the computational node;
for each layer of the tree network, appending an address that identifies an addressable port of a switching node of a set of switching nodes at the layer; and
asynchronously transmitting the packet via an asynchronous serial link of the tree network.

17. The method of claim 16, where the tree network comprises a binary tree (B-tree).

18. The method of claim 16, where the tree network comprises a self-similar fractal H-tree.

19. The method of claim 16, where the generating the payload comprises generating an exciting or inhibiting spike for the computational node.

20. The method of claim 16, where the generating the payload comprises assigning a neuromorphic weight for the computational node.
